(19) United States
(12) Patent Application Publication
(10) Pub. No.: US 2019/0193652 A1
(43) Pub. Date: Jun. 27, 2019

(54) HMI CONTROLLER

(71) Applicant: Dura Operating, LLC, Auburn Hills, MI (US)

(72) Inventors: Cumhur Unveren, Walled Lake, MI (US); Aaron Brion Stachewicz, Troy, MI (US); Jeff Hovis, Almont, MI (US)

(21) Appl. No.: 15/850,436

(22) Filed: Dec. 21, 2017

(51) Int. Cl. B60R 16/00; G06F 3/0362; G06F 3/01; G06F 3/0484; G06F 3/0481; B60Q 9/00

(52) U.S. Cl. CPC B60R 16/005; G06F 3/0362; B60Q 9/00; G06F 3/04842; G06F 3/0481; G06F 3/016

(57) ABSTRACT

A method for managing host vehicle functions includes receiving a first input to a human-machine interface (HMI) controller having an adjustable haptic feedback mechanism and an access interface, presenting an application access interface having a plurality of selectable applications, receiving a second input selecting one of the plurality of selectable applications, presenting an application management interface having a plurality of selectable functions, receiving a third input indicating a selected function of the plurality of functions, presenting information related to the selected function, actively adjusting the haptic feedback mechanism in the HMI controller based on the selected function within the selected application, and receiving a fourth input selecting a setting within the selected function.

### FIELD

The present disclosure relates generally to motor vehicle systems, and more specifically to systems and methods for controlling motor vehicle systems.

### BACKGROUND

The statements in this section merely provide background information related to the present disclosure and may or may not constitute prior art.

Vehicle systems have become increasingly complex with as the quantity and variety of systems operated or controlled electronically has grown. To manage a wide variety of parameters associated with engine, steering, braking, suspension, navigation, climate control, entertainment, advanced driver assistance systems (ADAS), and so forth, increasingly complex systems with increasingly numerous operator selectable settings are being used. Selectable settings can be managed in individual human-machine interface controllers (HMIs) associated with each of the systems, however with the rise of touch-screen interfaces in vehicles, many of the settings can now be accessed directly through a motor vehicle's head-unit or other such access points. While the ability to manage a wide variety of systems and settings is desirable, navigating through a menu structure that includes settings for such a variety of systems can be complex. When navigating to specific selectable settings within the interface or interfaces in the motor vehicle, it is common for occupants including the driver of the vehicle to focus on the interface or interfaces of the host vehicle 10. Focusing on the interfaces detracts from the amount of time that the driver is able to pay attention to the act of driving, or to the road. This is particularly true in cases where the HMI controller is primarily a touch-screen interface, because many such touch-screens provide little or no haptic feedback. Without haptic feedback navigating menu structures to access particular functions can be challenging without spending significant amounts of time looking directly at the touch-screen(s). That is, as menu structures to access specific functions become more complicated and/or convoluted, distracted driving becomes increasingly likely.

Thus, while current HMI controllers achieve their intended purpose in providing access to a wide variety of applications and selectable functions within motor vehicles, there is a need for new and improved systems and methods for accessing functionality within the motor vehicle while reducing the potential for driver distraction.

### SUMMARY

According to one aspect of the present disclosure a method for managing host vehicle functions includes receiving a first input to a human-machine interface (HMI) controller having an adjustable haptic feedback mechanism and an access interface such as a rotary interface, presenting an application access interface having a plurality of selectable applications, receiving a second input selecting one of the plurality of selectable applications, presenting an application management interface having a plurality of selectable functions, receiving a third input indicating a selected function of the plurality of functions, presenting information related to the selected function, actively adjusting the haptic feedback mechanism in the HMI controller based on the selected function within the selected application, and receiving a fourth input selecting a setting within the selected function.

In another aspect of the present disclosure receiving a first input includes accepting a biometric input.

In yet another aspect of the present disclosure receiving a first input includes receiving at least one of a fingerprint, a palm print, or a voice print.

In still another aspect of the present disclosure a method for managing host vehicle functions further includes receiving a conditional input.

In still another aspect of the present disclosure the conditional input includes a time, a temperature, a location, a solar position, a path designation, a destination, a road type, a vehicle position, or a vehicle status.

In still another aspect of the present disclosure presenting an application interface further includes presenting a subset of the plurality of selectable applications.

In still another aspect of the present disclosure the subset of selectable applications includes a customized group of applications associated with the first input.

In still another aspect of the present disclosure actively adjusting the haptic feedback mechanism further includes generating a plurality of detents in a rotational travel of the rotary access interface of the HMI controller.

In still another aspect of the present disclosure a quantity, a size, and a resistance of the plurality of detents varies in accordance with the selected function.

In still another aspect of the present disclosure receiving a fourth input selecting a setting within the selected function further includes receiving a rotary input to the rotary access interface of the HMI controller.

In still another aspect of the present disclosure a method for managing host vehicle functions includes receiving a biometric first input and a conditional input to a human-machine interface (HMI) controller with a rotary access interface having an adjustable haptic feedback mechanism, presenting an application access interface providing access to a plurality of vehicle functions through a plurality of selectable applications, receiving a second input selecting one of the plurality of selectable applications, presenting an application management interface having a plurality of selectable functions, receiving a third input selecting a function of the plurality of functions, presenting information related to a selected function, actively adjusting the haptic feedback mechanism in the HMI controller based on the selected function within the selected application, and receiving a fourth input selecting a setting within the selected function.

In still another aspect of the present disclosure presenting an application interface further includes presenting a subset of the plurality of selectable applications.

In still another aspect of the present disclosure the subset of selectable applications depends upon the first input.

In still another aspect of the present disclosure the biometric first input includes at least one of a fingerprint, a palm print, and a voice print, and wherein the conditional input includes at least one of a time, a temperature, a location, a solar position, a path designation, a destination, a road type, a vehicle position, and a vehicle status.

In still another aspect of the present disclosure actively adjusting the haptic feedback mechanism further includes generating a plurality of detents in a rotational travel of the rotary access interface of the HMI controller.

In still another aspect of the present disclosure a quantity, a size, and a resistance of the plurality of detents varies in accordance with the selected function.

In still another aspect of the present disclosure receiving a fourth input selecting a setting within the selected function further includes receiving a rotary input to the rotary access interface of the HMI controller.

In still another aspect of the present disclosure receiving a fourth input further includes receiving a lateral, a longitudinal, or a vertical input to the HMI controller.

In still another aspect of the present disclosure a system for managing host vehicle functions includes a human-machine interface (HMI) controller having a rotary portion and an adjustable haptic feedback mechanism, the HMI controller in electronic communication with the host vehicle, a biometric input in electronic communication with the HMI controller and the host vehicle, the biometric input receiving biometric data, an application access and management interface in electronic communication with the HMI controller and the biometric input, and accessing a plurality of applications, wherein the biometric input data received by the biometric input provides selective access to a subset of the plurality of applications, the rotary portion generates variable haptic feedback specifically associated with each application and functions within each application.

In still another aspect of the present disclosure the plurality of applications is a standardized application catalog, and the subset of the plurality of applications is a subset of the standardized application catalog, and wherein the subset of the standardized application catalog is specifically associated with the biometric input data.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way. In the drawings:

FIG. 1 is an environmental view of an HMI controller for use with a motor vehicle according to an aspect of the present disclosure;

FIG. 2A is a perspective view of an HMI controller according to an aspect of the present disclosure;

FIG. 2B is an exploded view of the HMI controller of FIG. 2A according to an aspect of the present disclosure; and

FIG. 3 is a flowchart of a method of using an HMI controller according to an aspect of the present disclosure.

### DETAILED DESCRIPTION

The following description is merely exemplary in nature and is not intended to limit the present disclosure, application, or uses.

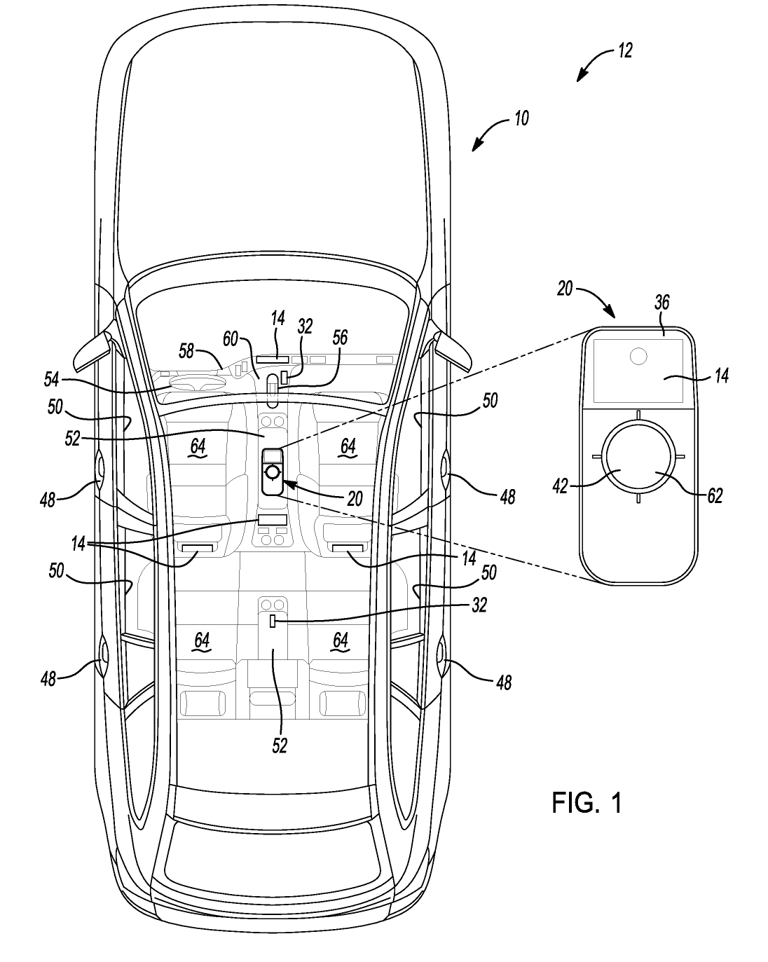

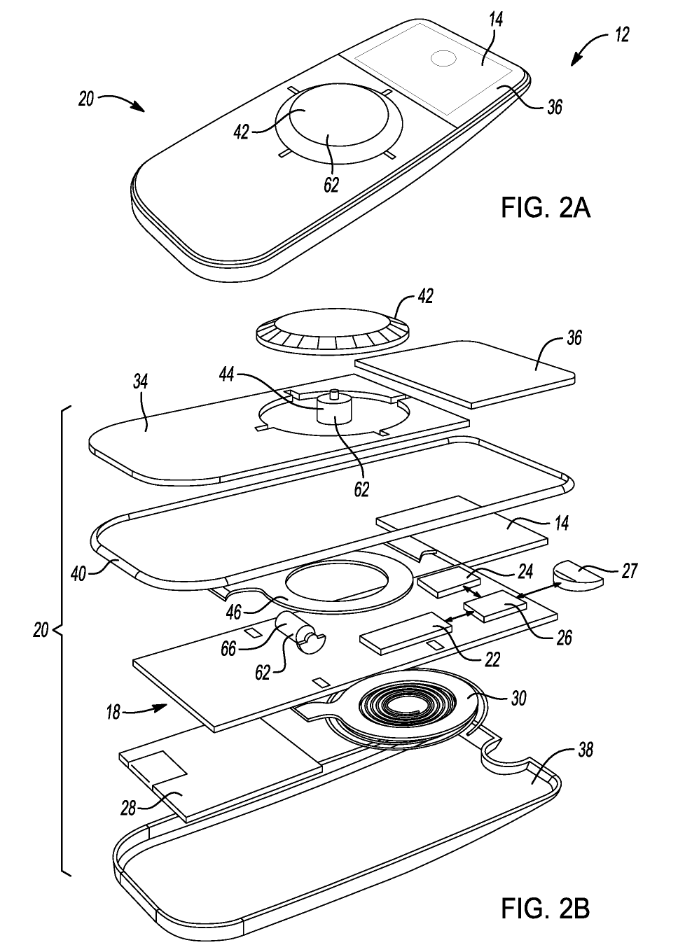

Referring to FIGS. 1-2B, a host vehicle is shown and generally indicated by reference number 10. The host vehicle 10 includes a system 12 for managing a variety of functions. The system 12 includes at least one display 14 operable to access a plurality of functions within a standardized application catalog (not shown). The standardized application catalog includes a plurality of host vehicle 10 sub-systems and functions, including, but not limited to: steering and steering settings, suspension and suspension settings, braking and braking settings, throttle and throttle mappings, audio settings, telephone connection settings, Bluetooth settings, wireless communication (WiFi) and WiFi Hotspot settings, navigational or GPS settings, vehicle status functions and information, climate control settings, audio and entertainment settings, and the like.

In several aspects, applications and functions within the standardized application catalog are also accessible via an application access and management interface or interfaces, or function control module 18. In some aspects, the function control module 18 is accessible via the display or displays 14 within the host vehicle 10. In other aspects, the function control module 18 is accessible via or disposed within a Human Machine Interface (HMI) controller 20 operable to interact with and control functionality of the system 12. The function control module 18 is in electronic communication with other portions of the HMI controller 20, and is associated directly with the individual applications and functions available within the standardized application catalog. The function control module 18 is a non-generalized electronic control device having a preprogrammed digital computer or processor 22, memory or non-transitory computer readable medium 24 used to store data such as control logic, instructions, image data, lookup tables, etc., and a plurality of input/output peripherals or ports 26. In some examples, the input/output peripherals or ports 26 are in electronic communication with an input/output device 27 within the HMI controller 20, such as an electromagnetic (EM) signal transmitter or receiver. The processor 22 is configured to execute the control logic or instructions. The function control module 18 may have additional processors 22 or additional integrated circuits in communication with the processor 22. The function control module 18 is electrically connected to a battery 28. In some aspects, the HMI controller 20 includes a wireless charging member 30 for induction charging on an induction charging dock 32. The function control module 18 can output to the display 14 for a vehicle occupant and can communicate with a plurality of vehicle systems, such as an audio/visual system, a climate control system, a lighting system, as well as vehicle driving dynamics systems, and the like.

The HMI controller 20 includes a faceplate 34 with a lens or lens cover 36 disposed over the display 14. The faceplate 34 and a bottom cover 38 sandwich a plurality of electrical components. A decorative bezel 40 surrounds a periphery of the HMI controller 20. In some aspects, the faceplate 34 includes a plurality of switches (not shown), and an access interface such as a rotary knob 42. The rotary knob 42 is disposed overtop a rotary motor 44. In some aspects, the rotary knob 42 may be better described as a capacitive device sensitive to touch. In other words, in some examples, the rotary knob 42 is disposed overtop a first or biometric input 46. The biometric input 46 is in electronic communication with the host vehicle 10, and more specifically, in electronic communication with the standardized application catalog of the function control module 18. In some aspects, the biometric input 46 is a part of the HMI controller 20. In other aspects, the biometric input 46 is located on an exterior door handle 48, an interior door handle 50, an arm rest 52, a steering wheel 54, a shifter lever 56, a dashboard 58, a console 60, or an interior or exterior camera (not shown). The biometric input 46 is a scanner or other recording apparatus within the host vehicle 10. The biometric input 46 records a physical characteristic of a user of the host vehicle 10, such as a fingerprint, palm print, vein scan, iris or retina scan, hand geometry scan, facial structure, voice scan, or the like. In another aspect, the biometric input 46 operates to record and catalog a behavioral characteristic, such as a pattern of system 12 usage, driving style, seat position, radio volume or station, or the like.

The function control module 18 receives biometric input data from the biometric input 46. Additional conditional data, such as a time, a temperature, a location, a solar position, a path designation, a destination, a road type, a vehicle position, a vehicle status, and the like is collected by a plurality of host vehicle 10 systems associated with each type of conditional data. The function control module 18 combines the biometric input data and the conditional data to selectively provide an operator of the HMI controller 20 access to a subset of the full standardized application catalog. The function control module 18 then maps selectable functions of the subset of applications to the display or displays 14 of the host vehicle 10 and/or the HMI controller 20 for the operator to access. In one aspect, the function control module 18 also maps selectable functions of the subset of applications to the display 14. For example, a driver/operator of the host vehicle 10 may have specific preferences regarding seating position, climate control, radio station, audio volume, instrument cluster brightness, interior lighting color, and so forth. As the driver/operator of the host vehicle 10 uses various functions of the host vehicle 10 over time, the function control module 18 accumulates data regarding how the driver/operator uses the various functions. The function control module 18 associates the usage data with a particular biometric input data received by the biometric input 46. Thus, as the driver/operator accesses the host vehicle 10 and generates biometric input data, the function control module 18 applies preferred settings for the specific driver/operator using the system 12. In another example, the driver/operator of the host vehicle 10 may directly input applications, functions, and settings to be saved as favorites within the standardized application catalog, thereby manually generating the subset of the full standardized application catalog.

In a specific non-limiting example, a driver accesses the host vehicle 10 at the end of the work-day via the exterior door handle 48. A biometric input 46 is disposed in the exterior door handle 48, and sends biometric input data to the function control module 18. The driver has previously set a specific radio station and volume on the host vehicle's 10 stereo system. Based on the biometric input data transmitted to the function control module 18, the same radio station and volume settings are applied to the host vehicle's 10 stereo, as well as being depicted on the display 14, and being made accessible directly via the HMI controller 20. In addition to the volume and station selections, based on the time of day at which the driver is using the host vehicle 10, the function control module 18 applies settings to the GPS including route selection to the driver's home and traffic information including selecting the most time-efficient route and depicts the route and traffic information on the display 14. In another specific example, the biometric input 46 is disposed on the shifter lever 56, and a driver who has previously operated the host vehicle 10 enters and begins to drive the host vehicle 10 to an unfamiliar destination. Based on the completely new destination information input into the GPS, the function control module 18 adjusts settings on the navigation system, stereo system, and phone connection or Bluetooth systems. The function control module's 18 adjustments improve route clarity, reduce audio volume (except for navigational instructions), and alters operation of the driver's phone to reduce potential sources of driver distraction, thereby improving driving safety. While in the above discussion, the function control module 18 is described as managing host vehicle 10 stereo and GPS information, it should be understood that the function control module 18 interacts with and controls access to and functions of a wide variety of host vehicle 10 systems. Furthermore, it should be understood that a plurality of applications of the subset of the standardized application catalog may be displayed or accessed simultaneously.

Turning now to FIGS. 2A and 2B, and with continuing reference to FIG. 1, the HMI controller 20 further includes a rotary knob 42. The rotary knob 42 is manipulated by an operator's hand. The rotary knob 42 is mechanically connected to a haptic feedback mechanism 62. In some aspects, the haptic feedback mechanism 62 provides multiple feedback types to the operator. In one aspect, the haptic feedback mechanism 62 includes a rotary motor 44 providing variable torque to rotational motion of the rotary knob 42. In an example, as an operator manipulates the rotary knob 42, the rotary motor 44 provides a torque that resists movement of the rotary knob 42 such that the torque is commensurate with a particular application or function that the operator is accessing within the HMI controller 20. In other words, in an example in which the operator is accessing a temperature setting function within a climate control application via the HMI controller 20, the function control module 18 directs the rotary motor 44 to provide torque that replicates a plurality of detents in the motion of the rotary knob 42. In another example, when the operator accesses a radio volume function within an entertainment application via the HMI controller 20, the function control module 18 directs the rotary motor 44 to generate a torque that replicates the movement of a smooth heavily-weighted mechanical stereo knob, or other rheostatic device. While the torque provided by the rotary motor 44 has been described above as a plurality of detents, or a smooth heavily-weighted mechanical stereo knob, it should be understood that a wide variety of different torque types can be provided depending on the particular function and application being accessed via the HMI controller 20. Furthermore, while the system 12 is shown as having only a single HMI controller 20 in FIG. 1, it should be understood that the system 12 may include a plurality of HMI controllers 20 without departing from the scope or intent of the present disclosure. For example, the system 12 may include HMI controllers 20 accessible by operators at each of the seats or seating positions 64 depicted in FIG. 1. The HMI controllers 20 may be placed in an interior door handle 50, an arm rest 52, a steering wheel 54, a shifter lever 56, a dashboard 58, a console 60 or the like.

In another aspect, the haptic feedback mechanism 62 includes a vibration motor 66 generating vibrations perceptible by the operator via the HMI controller 20. In one aspect, the vibration motor 66 is disposed within the HMI controller 20 and generates vibrational feedback as an operator manipulates the HMI controller 20. In another aspect, the vibration motor 66 is entirely separate from the HMI controller 20 and the rotary knob 42. For instance, the vibration motor 66 may be placed in a number of locations in the host vehicle 10 where the operator can perceive the vibrations, such as within an interior door handle 50, an arm rest 52, a steering wheel 54, a shifter lever 56, a dashboard 58, a console 60, a seat 64 or the like. Additionally, while in the above description, the vibration motor 66 has been discussed as a solitary unit, it should be understood that a plurality of vibration motors 54 may be placed throughout the host vehicle 10 in locations where haptic feedback is advantageous as the HMI controller 20 is manipulated by an operator, or by a plurality of occupants of the host vehicle 10. In one example, when the operator manipulates the HMI controller 20 to select an application, a function, or a setting within either, the function control module 18 directs the vibration motor 66 to generate a vibration indicating that a selection has been made. In a more specific example, a driver uses the HMI controller 20 to select a communications system (not shown), pair the driver's cellular phone (not shown) with the audio system (not shown) of the host vehicle 10, select a phone number stored in a memory of the cellular phone, and then call the phone number. For each of the above selections (four selections in this particular example), the vibration motor 66 disposed in the HMI controller 20 generates a vibration having a short duration, for example, less than a second, indicating that a driver input or selection is being made, thereby transmitting tactile confirmation of the driver's selections to the driver. While the vibrations generated by the vibration motor 66 have been described as being less than a second in duration, it should be understood that the duration of the vibration generated may vary substantially, but should generally be commensurate with the types of selections the operator of the system 12 makes.

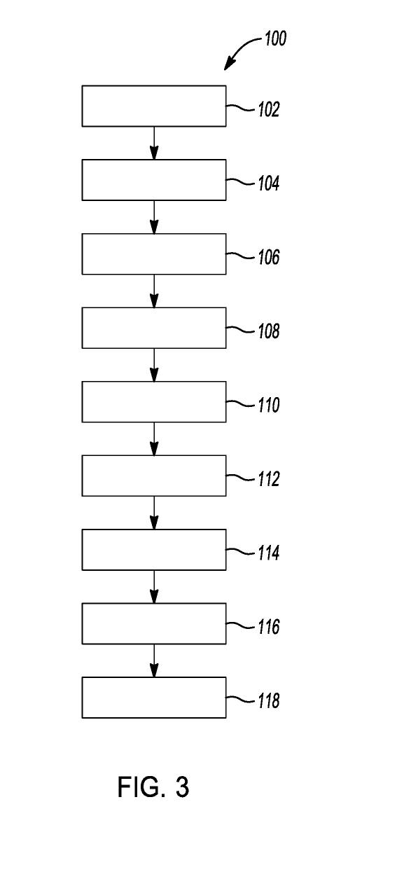

Turning now to FIG. 3 and with continuing reference to FIGS. 1-2B, a method for managing functions of the host vehicle 10 is depicted. The method begins at block 100 where the biometric input 46 receives biometric input data generated by the operator of the host vehicle 10. At block 102, the function control module 18 receives conditional data. At block 104, the function control module 18 combines the biometric input data and the conditional data and selects a subset of applications of the standardized application catalog is associated with preferences, previous selections, and situational information relating to the current operator and situation. At block 106, the function control module 18 of the system 12 presents an application interface on the HMI controller 20 and in some examples, on the display 14 as well. At block 108, the operator selects an application of the subset of applications, and the haptic feedback mechanism 62 generates haptic feedback associated with the application selection. At block 110, the function control module 18 of the system 12 determines a plurality of selectable functions relating to the selected application, and at block 112, the function control module 18 presents an application management interface (not shown) having the plurality of selectable functions. At block 114, the operator selects a function, and the haptic feedback mechanism 62 generates haptic feedback associated with the function selection. At block 116, the function control module 18 determines information relating to the selected function and displays the information on the HMI controller 20 and in some aspects, on the display 14 as well. At block 118, the function control module 18 determines haptic feedback relating to the selected function, and actively adjusts the haptic feedback mechanism 62 in the HMI controller 20 based on the selected function within the selected application.

The HMI controller 20 and the system 12 of the present disclosure offers several advantages. These include ease of use, portability, broad functionality, simplicity of construction, redundancy, and improved road safety. The description of the present disclosure is merely exemplary in nature and variations that do not depart from the gist of the present disclosure are intended to be within the scope of the present disclosure. Such variations are not to be regarded as a departure from the spirit and scope of the present disclosure.

1. A method for managing host vehicle functions, the method comprising:
receiving a first input to a human-machine interface (HMI) controller having an adjustable haptic feedback mechanism and an access interface;
presenting an application access interface having a subset of a plurality of selectable applications based on the first input;
receiving a second input selecting a selected application from the subset of the plurality of selectable applications;
presenting an application management interface having a plurality of selectable functions based on the selected application;
receiving a third input indicating a selected function of the plurality of functions;
presenting information related to the selected function; and
actively adjusting the haptic feedback mechanism in the HMI controller based on the selected function within the selected application.

2. The method of claim 1 wherein receiving a first input comprises accepting a biometric input.

3. The method of claim 2 wherein receiving a first input comprises receiving at least one of a fingerprint, a palm print, or a voice print.

4. The method of claim 1 further comprising receiving a conditional input.

5. The method of claim 4 wherein the conditional input comprises a time, a temperature, a location, a solar position, a path designation, a destination, a road type, a vehicle position, or a vehicle status.

6. The method of claim 1 wherein presenting the subset of the plurality of selectable applications includes presenting less than all of the plurality of selectable applications.

7. The method of claim 6 wherein the subset of selectable applications comprises a customized group of applications associated with the first input.

8. The method of claim 1 wherein actively adjusting the haptic feedback mechanism further comprises generating a plurality of detents in a rotational travel of the access interface of the HMI controller.

9. The method of claim 8 wherein a quantity, a size, and a resistance of the plurality of detents varies in accordance with the selected function.

10. The method of claim 1 wherein presenting the application management interface having the plurality of selectable functions based on the selected application further includes presenting the application management interface having the plurality of selectable functions based on the selected application and the first input.

11. A method for managing host vehicle functions, the method comprising:
receiving a biometric first input and a conditional input to a human-machine interface (HMI) controller with an access interface having an adjustable haptic feedback mechanism;
presenting an application access interface providing access to a plurality of vehicle functions through a subset of a plurality of selectable applications based on the biometric first input and the conditional input;
receiving a second input selecting one of the plurality of selectable applications;
presenting an application management interface having a subset of a plurality of selectable functions based on the biometric first input, the conditional input, and the second input;
receiving a third input selecting a function of the subset of the plurality of functions;
presenting information related to a selected function;
actively adjusting the haptic feedback mechanism in the HMI controller based on the biometric first input and the selected function within the selected application; and
receiving a fourth input selecting a setting within the selected function.

12. The method of claim 11 wherein presenting the subset of the plurality of selectable applications includes presenting less than all of the plurality of selectable applications based on the biometric first input and the conditional input.

13. The method of claim 12 wherein the conditional input is a function of host vehicle conditions or ambient environmental conditions.

14. The method of claim 11 wherein the biometric first input comprises at least one of a fingerprint, a palm print, and a voice print, and wherein the conditional input comprises at least one of a time, a temperature, a location, a solar position, a path designation, a destination, a road type, a vehicle position, and a vehicle status.

15. The method of claim 11 wherein actively adjusting the haptic feedback mechanism further comprises generating a plurality of detents in a rotational travel of the access interface of the HMI controller.

16. The method of claim 15 wherein a quantity, a size, and a resistance of the plurality of detents varies in accordance with the selected function.

17. The method of claim 11 wherein receiving a fourth input selecting a setting within the selected function further comprises receiving a rotary input to the access interface of the HMI controller.

18. The method of claim 17 wherein receiving a fourth input further comprises receiving a lateral, a longitudinal, or a vertical input to the HMI controller.

19. A system for managing host vehicle functions comprising:
a human-machine interface (HMI) controller having a rotary portion and an adjustable haptic feedback mechanism, the HMI controller in electronic communication with the host vehicle;
a biometric input in electronic communication with the HMI controller and the host vehicle, the biometric input receiving biometric data;
an application access and management interface in electronic communication with the HMI controller and the biometric input, and accessing a plurality of applications,
wherein the biometric input data received by the biometric input provides selective access to a subset which is less than all of the plurality of applications, functions provided by the plurality of applications are customized based on the biometric input data, and the rotary portion generates variable haptic feedback specifically associated with each application and functions within each application.

20. The system of claim 19, wherein the plurality of applications is a standardized application catalog, and the subset of the plurality of applications is a subset of the standardized application catalog, and wherein the subset of the standardized application catalog is specifically associated with the biometric input data.
